(19) United States
(12) Patent Application Publication
(10) Pub. No.: US 2006/0206519 A1
(43) Pub. Date: Sep. 14, 2006

(54) Document managing apparatus

(75) Inventors: Noriyuki Komamura, Mishima-shi (JP); Nobuhiro Shimogori, Kawasaki-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/077,772

(22) Filed: Mar. 10, 2005

(51) Int. Cl. G06F 17/00

(52) U.S. Cl. 707/104.1

(57) ABSTRACT

A document managing apparatus has a memory in which files are classified and stored, detects an updated file from the files stored in the memory, and combines the detected file with an image data file stored in the memory in the same class as that of the file in a case where the detected updated file is the image data file to manage a plurality of combined image data files as one document.

### BACKGROUND OF THE INVENTION

1. Field of the Invention

The present invention relates to a document managing apparatus which manages a file stored in a memory as a document using an information processing apparatus such as a computer.

2. Description of the Related Art

There has heretofore been a document managing apparatus which manages as a document a file stored in a hard disk drive (HDD). This type of document managing apparatus has a function of searching a plurality of documents being managed for user's desired document. For example, the document managing apparatus displays in a display information indicating a state of the document being managed, information indicating a document being selected by user's operation and the like. Accordingly, the user searches for the desired document based on the information indicating the document displayed in the display.

Moreover, the document managing apparatus manages each file stored in the HDD as each document. However, as to image data, each image is stored as one file in the HDD in many cases. Therefore, in the above-described document managing apparatus, when a large amount of image data files are stored in the HDD, there is a necessity of managing a large amount of documents. When each file of a large amount of image data is managed as the document, there is a problem that a searching efficiency is deteriorated for the user in searching for the desired document.

### BRIEF SUMMARY OF THE INVENTION

According to the present invention, there is provided a document managing apparatus comprising: storage means for classifying and storing files; detecting means for detecting an updated file from the files stored in the storage means; judging means for judging whether or not the file detected by the detecting means is a file of image data; combining means for combining the detected file with a file of image data stored in the storage means in the same class as that of the file in a case where the judging means judges that the file detected by the detecting means is the image data; and document managing means for managing as one document a plurality of image data files combined by the combining means.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the intention.

FIG. 1 is a block diagram schematically showing a constitution example of a document managing apparatus according to an embodiment of the present invention;

FIG. 2 is a diagram showing a constitution example of a mouse;

FIG. 3 is a diagram showing a display example of a document searching screen (display screen of a document) displayed in a display of the document managing apparatus;

FIG. 4 is a diagram showing a relation between a document managed by the document managing apparatus and an image displayed in an image display region;

FIG. 5 is a diagram showing a constitution example of a first file management table;

FIG. 6 is a diagram showing a constitution example of a second file management table;

FIG. 7 is a diagram showing a constitution example of a document management table;

FIG. 8 is a diagram showing a constitution example of the document management table;

FIG. 9 is a diagram showing a constitution example of the document management table;

FIG. 10 is a diagram showing a constitution example of a color management table;

FIG. 11 is a flowchart showing a registering process of document management information in the document managing apparatus;

FIG. 12 is a flowchart showing an image combining process in the registering process of the document management information;

FIG. 13 is a flowchart showing an image producing process in the document managing apparatus;

FIG. 14 is a flowchart showing a displaying process of the document searching screen in the document managing apparatus;

FIG. 15 is a flowchart showing a document map producing process in the document managing apparatus;

FIG. 16 is a flowchart showing a document searching process in the document managing apparatus;

FIG. 17 is a flowchart showing the document searching process in the document managing apparatus;

FIG. 18 is a flowchart showing the document searching process in the document managing apparatus;

FIG. 19 is a flowchart showing an example of a displaying process of a cover image; and

FIG. 20 is a flowchart showing a modification of the displaying process of the cover image.

### DETAILED DESCRIPTION OF THE INVENTION

An embodiment of the present invention will be described in detail with reference to the drawings.

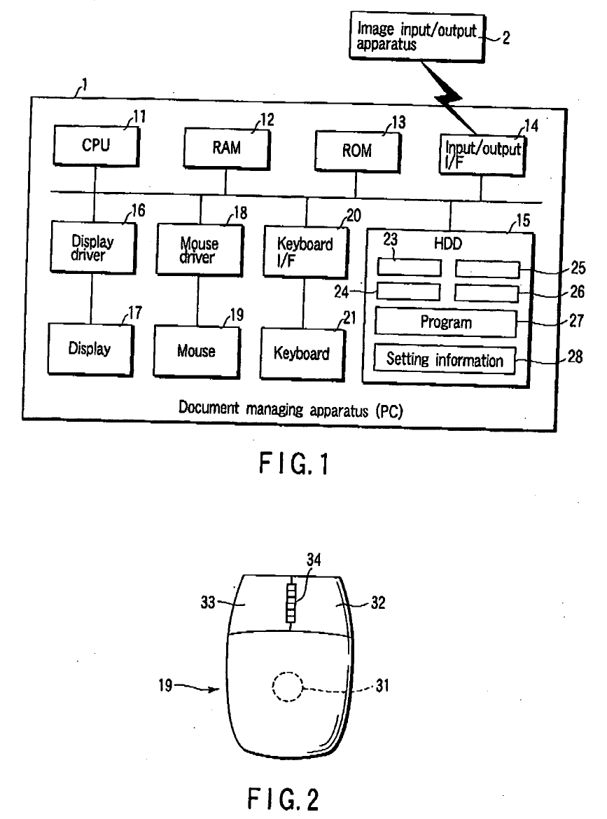

FIG. 1 is a block diagram schematically showing a constitution example of a document managing apparatus 1 according to an embodiment of a document searching apparatus of the present invention.

The document managing apparatus 1 functions as a document searching apparatus, and comprises a PC and the like connected to a document input/output apparatus 2. The document input/output apparatus 2 is not limited as long as the apparatus supplies an image to the document managing apparatus 1 which is the PC. Assumed examples of the document input/output apparatus 2 include a scanner, a digital complex machine (MFP) comprising the scanner, a digital camera, a computer on network (e.g., WWW server) and the like.

As shown in FIG. 1, the document managing apparatus 1 comprises a CPU 11, a RAM 12, a ROM 13, an input/output interface (I/F) 14, a hard disk drive (HDD) 15, a display driver 16, a display 17, a mouse driver 18, a mouse 19, a keyboard interface (I/F) 20, a keyboard 21 and the like. The mouse 19 and the keyboard 21 are input devices.

The CPU 11 executes a general control of the document managing apparatus 1. The CPU 11 executes a control program stored in the ROM 13 or an application program stored in the HDD 15 to thereby realize various functions. The CPU 11 is also provided with a timer 11a which counts time. The RAM 12 is a memory which temporarily stores data for operation and the like. The ROM 13 is a nonvolatile memory in which a basic control program for operating the document managing apparatus (PC) 1 is stored beforehand.

The input/output interface 14 is an interface for inputting data such as an image from an external apparatus. In the constitution example shown in FIG. 1, the input/output interface 14 functions as an interface for acquiring an image from the document input/output apparatus 2. It is to be noted that FIG. 1 shows one input/output interface 14, but the document managing apparatus 1 may be provided with a plurality of input/output interfaces 14.

The HDD 15 functions as storage means. The HDD 15 is a storage device comprising a magnetic disk and the like. In the HDD 15, various types of data are stored in a file form. That is, the data constituting the document which is the management object of the document managing apparatus 1 is stored as a file in the HDD 15.

Moreover, the HOD 15 is provided with a folder for storing a file. The folder can be operated as information indicating classification of each file. That is, when associated data files are stored in a specific folder, a plurality of files can be classified and stored in the HDD 15. For example, when the files of image data photographed with a digital camera are stored together in a specific folder, the files can be classified and stored in the HDD 15.

Moreover, the HDD 15 is provided with a first file management table 23 which is a data table, a second file management table 24, a document management table 25, a color management table 26 and the like.

The first and second file management tables 23 and 24 are tables to store management information (file management information) concerning the file of the data constituting the document which is the management object. The document management table 25 is a table to store management information (document management information) on the document which is the management object. The color management table 26 is a table to store information (color management information) on a color associated with the document which is the management object. It is to be noted that the respective data tables 23 to 26 will be described later in detail.

Moreover, in the HDD 15, at least an application program (program for document management) 27 for allowing a PC to function as the document managing apparatus 1, and setting information 28 are stored.

The program 27 for document management comprises a program for allowing the PC to execute various types of processes such as a registering process of the document management information, an image producing process, a displaying process of a document searching screen, a document map producing process, and a document searching process. That is, when the program 27 for document management is executed, the PC realizes various types of functions such as a function of registering the document management information, a function of producing an image, a function of displaying the document searching screen, a function of producing the document map (bar for searching), and a function of searching the document.

The display driver 16 comprises a driving circuit which controls display contents of the display 17. The display driver 16 functions as an interface which outputs a signal of an image displayed in the display 17 to the display 17. The mouse driver 18 comprises a circuit which detects information input into the mouse 19 and the like. The mouse driver 18 detects movement of the mouse 19, input into a button disposed in the mouse 19, a rotation amount of a wheel disposed in the mouse 19 or the like. The mouse driver 18 notifies the CPU 11 of a signal indicating movement of the mouse 19, the input into the button of the mouse 19, the rotation amount of the wheel of the mouse 19 or the like.

The keyboard interface 20 detects information input in the keyboard 21, and notifies the CPU 11 of the information. The keyboard 21 comprises a plurality of keys of characters, numerals, symbols and the like. The input into each key of the keyboard 21 is detected by the keyboard interface 20, and notifies to the CPU 11 as a signal indicating the input key.

FIG. 2 is a diagram showing a constitution example of the mouse 19.

As shown in FIG. 2, the mouse 19 has an operation detection mechanism 31, a right button 32, a left button 33, a wheel 34 and the like. The mouse 19 is operated in a state shown in FIG. 2 when laid on a flat face The mouse 19 having the state shown in FIG. 2 is held with user's hand. The user moves the mouse 19 having the state shown in FIG. 2 on the flat face, and operates the right button 32, left button 33, and wheel 34 if necessary.

The operation detection mechanism 31 is a mechanism for converting the movement of the mouse 19 on the flat face into a signal. For example, the operation detection mechanism 31 comprises a spherical body which rotates in accordance with the movement of the mouse 19, and a mechanism which converts the movement of the spherical body into the signal. The operation detection mechanism 31 may comprise an optical sensor which detects the movement of the mouse 19 on the flat face, the mechanism which converts the movement of the mouse 19 detected by the optical sensor into a signal. The operation detection mechanism 31 is disposed on a side brought into contact with the flat face in the state shown in FIG. 2. That is, when the user moves the mouse 19 held in the state shown in FIG. 2, the operation detection mechanism 31 detects the movement of the mouse 19 on the flat face. The signal indicating the movement of the mouse detected by the operation detection mechanism 31 is output to the mouse driver 18.

The right button 32 is a button disposed on the right side of a mouse 19 main body in the state shown in FIG. 2. The right button 32 is a button operated by user's index finger, middle finger or the like in a case where the user holds the mouse 19 main body having the state shown in FIG. 2 with user's right hand. The left button 33 is a button disposed on the left side of the mouse 19 main body in the state shown in FIG. 2. The left button 33 is operated by user's middle finger, third finger or the like in a case where the user holds the mouse 19 main body having the state shown in FIG. 2 with user's right hand.

The wheel 34 is a rotary member disposed in the vicinity of a middle portion of the mouse 19 in the state shown in FIG. 2. In the example shown in FIG. 2, the wheel 34 is disposed between the right button 32 and the left button 33. For example, the wheel 34 is operated with the index finger, middle finger, third finger or the like of the user who holds the mouse 19 main body having the state shown in FIG. 2.

Moreover, the wheel 34 is disposed in such a manner as to rotate only in a certain direction. In the example shown in FIG. 2, the wheel 34 rotates in a direction an inward direction (upward direction of FIG. 2) and a reverse direction (downward direction of FIG. 2). In the following description, as to the rotation direction of the wheel 34, it is assumed that an inward (upward in FIG. 2) rotation direction is a positive direction, and a frontward (downward in FIG. 2) rotation direction is the reverse direction.

Furthermore, the wheel 34 may function as a button. In this case, the wheel 34 is constituted in such a manner as to perform a specific input, when the wheel 34 itself is pressed, Additionally, the wheel 34 may be constituted in such a manner as to perform a specific input, when pressed toward the right or left.

Next, a display screen (document searching screen) will be described with respect to the document managed by the document managing apparatus 1.

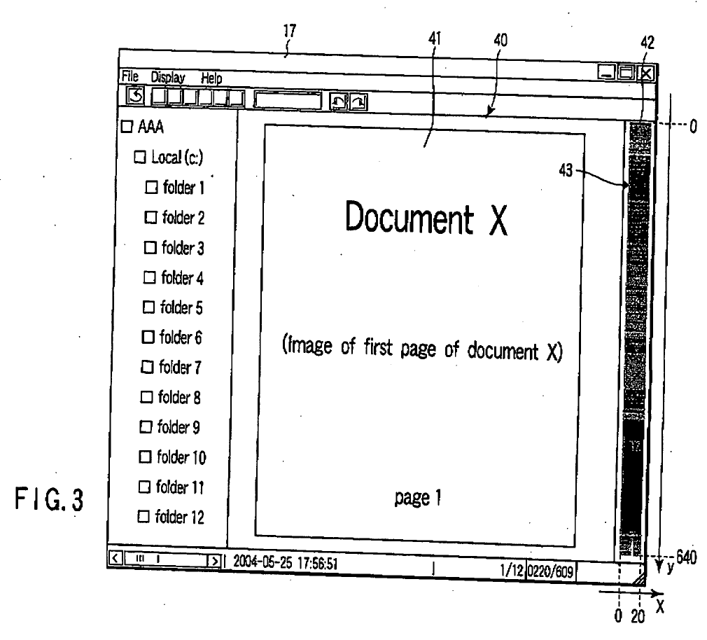

FIG. 3 is a diagram showing a display example of a document searching screen (display screen of the document) 40 displayed in the display 17 of the document managing apparatus 1.

In the document managing apparatus 1, the document searching screen 40 is displayed in a display window displayed in the display 17. As shown in FIG. 3, the document searching screen 40 displays an image of each page constituting the document managed by the document managing apparatus 1 every page unit in accordance with user's operation. The user searches the desired document with reference to the image displayed in the document searching screen 40 shown in FIG. 3.

In the display example shown in FIG. 3, the document searching screen 40 displays tool bars including various types of operation keys, and additionally an image display region 41, a document map (bar for searching) 42, a pointer (arrow) 43 and the like.

The image display region 41 is a substantially middle region of a display window which is the document searching screen 40 displayed in the display 17. Images of one or a plurality of pages constituting the document are displayed every page unit in accordance with user's operation in the image display region 41.

The document map 42 is displayed in a right-end region of the document searching screen 40. In the document map 42, bars (lines) indicating the respective documents managed by the document managing apparatus 1 are stacked and displayed in order of time series. This shows that the respective documents managed by the document managing apparatus l are stacked. In the document map 42 shown in FIG. 3, an uppermost bar indicates a document (newest document) having latest document time, and a lowermost bar indicate a document (oldest document) having an oldest document time. That is, in the document map 42 shown in FIG. 3, the upper bar indicates a newer document, and the lower bar indicates an older document among the bars.

The pointer 43 is displayed in a region adjacent to the document map 42 in the document searching screen 40. The pointer 43 indicates a position of the bar on the document map 42, and the bar indicates a document to which the image displayed in the image display region 41 belongs. That is, the pointer 43 indicates the position of the bar indicating the document being display in the document map 42.

Moreover, in the document map 42, each bar corresponding to each document is displayed in a color associated with each document. The color of each bar corresponding to each document displayed in the document map 42 is set for each folder in which the file of the data constituting the document is stored. In this case, the document whose data is stored in the same folder is displayed in the same color. The document whose data is stored in a different folder is displayed in a different color. Accordingly, the user can intuitively recognize the folder in which each document is stored by the color displayed in the document map 42. It is to be noted that the color of the bar corresponding to each document displayed in the document map 42 may be set for each extension of each file which is the document, or each application for opening the document.

Next, switching of an image will be described which is displayed in the image display region 41 of the document searching screen 40.

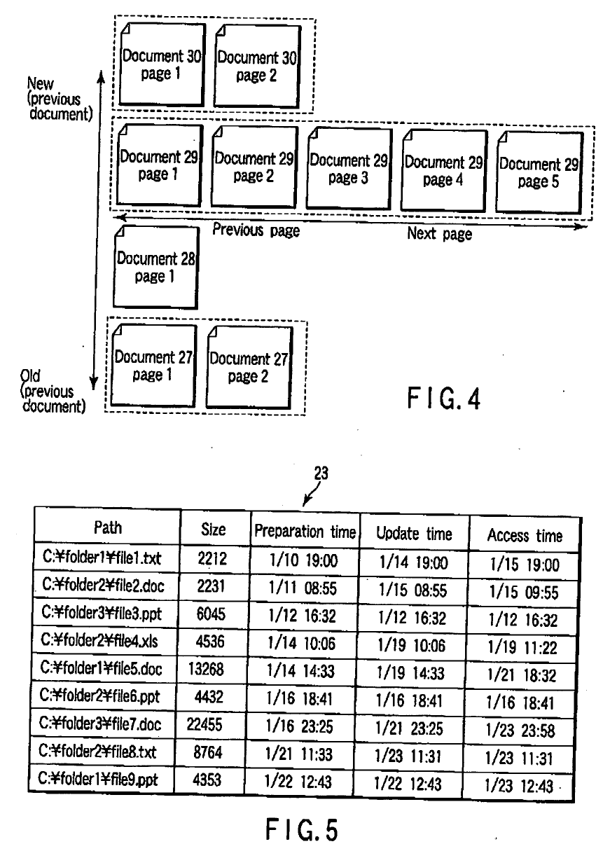

FIG. 4 is a diagram showing a relation between a document managed by the document managing apparatus 1 and an image displayed in the image display region 41.

Each document managed by the document managing apparatus 1 is constituted of one or a plurality of pages as shown in FIG. 4. The image shown in the image display region 41 of the document searching screen 40 shown in FIG. 3 is switched in response to an input of the mouse 19 or keyboard 21. The switching of the image displayed in the image display region 41 includes the switching of the document and the switching of the page.

In the document managing apparatus 1, as shown in FIG. 4, a plurality of documents are managed in order of time series based on a document time such as a document preparation time and an update time. The order of each document is also reflected in display order of the bar corresponding to each document stacked and displayed in the document map 42. Therefore, as shown in FIG. 3, the bars corresponding to the respective documents are stacked/displayed in order of time series in the document map 42.

Furthermore, in the document managing apparatus 1, as shown in FIG. 4, a plurality of pages in each document are managed in order of page.

In the document managing apparatus 1, the document displayed in the document searching screen 40 is switched in response to the operation of the mouse 19 or the keyboard 21 in a vertical direction (up/down direction of FIG. 3). Further in the document managing apparatus 1, the page displayed in the document searching screen 40 is switched in response to the operation of the mouse 19 or the keyboard 21 in a lateral direction (right/left direction of FIG. 3).

That is, when the user performs the operation in the vertical direction with the mouse 19, the keyboard 21 or the like, the document managing apparatus 1 switches the document to be displayed in the image display region 41 of the document searching screen 40. As a result, the image display region 41 of the document searching screen 40 displays a representative image (e.g., the image of a first page of the document) of the document switched in response to the operation in the vertical direction by the user. When the user performs the operation in the lateral direction with the mouse 19, the keyboard 21 or the like, the document managing apparatus 1 switches the page to be displayed in the image display region 41 of the document searching screen 40. As a result, the image display region 41 of the document searching screen 40 displays an image of the page switched in response to the operation in the lateral direction by the user.

First, the switching will be described with respect to the image to be displayed in the image display region 41 of the document searching screen 40 every document unit.

The document is switched, when the user instructs the switching of the document by an input device, for example, the mouse 19, the keyboard 21 or the like. Here, as described above, the document which is the image to be displayed in the image display region 41 is switched in response to the operation in the vertical direction (up/down direction). For example, the document is switched in response to the input into an up/down cursor key (up and down keys) of the keyboard 21, or the operation in the vertical direction by the pointing device like the mouse 19 or the like. In the present embodiment, the operation in the vertical direction will be described with respect to the switching of the document in accordance with a rotation amount of the wheel 34 of the mouse 19, which rotates in a forward/backward direction. The switching of the document by the wheel 34 of the mouse 19 will be described later in detail.

When the document is switched by the above-described operation, the image of the first page is displayed as the representative image of the document in the image display region 41 of the document searching screen 40. That is, every time the document is switched by the mouse 19, the keyboard 21 or the like, the image of the first page of each document is successively displayed in the image display region 41. It is to be noted that a specific page among the respective pages of the document may be Set as the representative image of each document.

That is, to switch the representative image (image of the first page) of the document displayed in the image display region 41, the user instructs the switching of the document by the input device like the mouse 19 or the keyboard 21. Then, the document managing apparatus 1 successively switches the image of the first page of the document displayed in the image display region 41 in order of time series of each document.

Next, a case will be described where the image displayed in the image display region 41 of the document searching screen 40 is switched every page unit.

The page is switched, when the user instructs the switching of the page by the input device like the mouse 19, the keyboard 21 or the like. Here, as described above, the page which is the image to be displayed in the image display region 41 is switched in response to the operation in the lateral direction. For example, the page is switched in response to the input into a right/left cursor key (right and left keys) of the keyboard.

Every time the page is switched by the above described operation, the image of each page constituting the document being displayed is successively displayed in the image display region 41 of the document searching screen 40. That is, to display the specific page of the specific document in the image display region 41, the user first displays the image of the first page of the desired document in the image display region 41 by the above-described switching of the document. In this display state, the user instructs the switching of the page by the mouse 19 or the keyboard 21. Then, the document managing apparatus 1 successively displays the image of each page constituting the document being displayed in the image display region 41 in order of page.

Next, various types of data tables 23 to 26 will be described for managing the document in the document managing apparatus 1 constituted as described above.

In the document managing apparatus 1, the data constituting each document which is a management object is stored as a file in the HDD 15. The file of the data constituting the document stored in the HDD 15 is managed by the first and second file management tables 23, 24. Management information of the document corresponding to the file stored in the HDD 15 is managed by the document management table 25. The color of the bar is managed by the color management table 26. This bar indicates each document in the document map 42 of the document searching screen 40.

First, the first and second file management tables 23, 24 will be described.

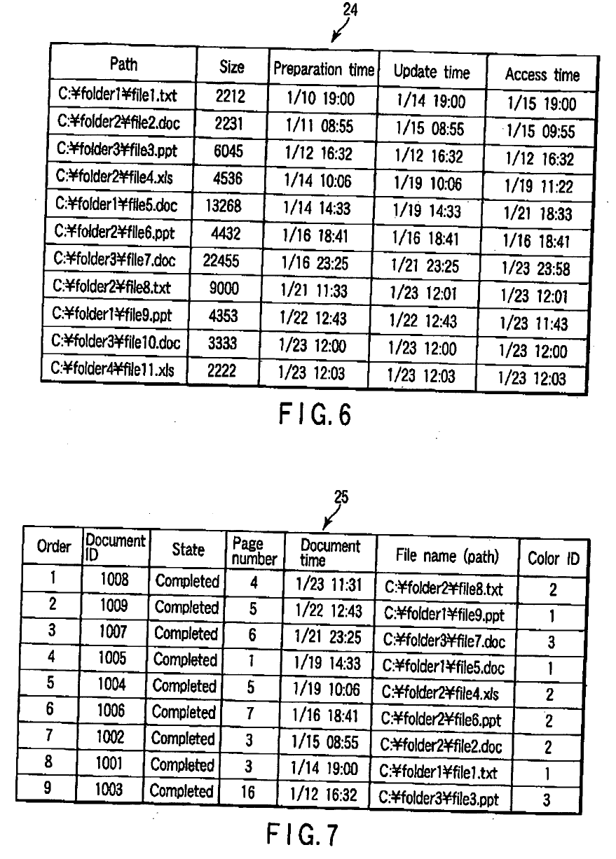

FIG. 5 is a diagram showing a constitution example of the first file management table 23. FIG. 6 is a diagram showing a constitution example of the second file management table 24.

The first and second file management tables 23, 24 are tables to store the management information on each file which is each document managed by the document managing apparatus 1.

As shown in FIGS. 5 and 6, the first and second file management tables 23, 24 are constituted to store the management information of each file, including a path, size, preparation time, update time, access time and the like.

As the path, information indicating a file name of the file is stored together with the information indicating names of a drive and a folder in which the file exists. A data size of the file is stored as the size. A date when the file was prepared is stored as the preparation time. A date when the file was updated is stored as the update time. As the access time, a date when the file was last accessed is stored.

Moreover, the management information of each file at a past time is stored in the first file management table 23. Here, the past time means, for example, a time when the document managing apparatus 1 was previously started. On the other hand, the second file management table 24 shows a list of existing files. Therefore, the second file management table 24 is updated in response to update and addition of the file at any time.

For example, when the document managing apparatus 1 is started, the information of the second file management table 24 at this time is stored as a first file management table, and a new second file management table 24 is prepared (updated). In the second file management table 24, management information is stored concerning a newly added file and an updated file. In other words, a difference between the file at the previous starting time and that at the present starting time appears as a difference between the first and second file management tables 23, 24. In the present embodiment, an updated situation (new registration or update) of the file is judged by the difference between the first and second file management tables 23, 24.

Here, as an example of the new registration of the file, a case is assumed where the document managing apparatus 1 acquires a document comprising a plurality of pages of images via the input/output interface 14. In this case, the data of the document acquired via the input/output interface 14 is stored as the newly registered file in the HDD 15. In this case, a field is added to the second file management table 24 in such a manner as to store the management information on the file, and a path, size, preparation time, update time, access time and the like are stored as the management information of the newly registered file. It is to be noted that in this case the information of the first file management table 23 is held without being changed.

Moreover, as an example of the update of the file, the update is assumed with respect to a file whose management information exists in the second file management table 24. In this case, the updated file is overwritten/stored in the existing file in the HDD 15. In this case, the management information of the file in the second file management table 24 is rewritten based on the file whose information has been updated including the size, update time, access time and the like. It is to be noted that also in this case, the information of the first file management table 23 is held without being changed.

Next, the document management table 25 will be described.

FIGS. 7, 8, and 9 are diagrams showing constitution examples of the document management table 25.

The document management table 25 is a table for managing as the document the file managed by the first file management table 23. It is to be noted that the document management table 25 is document managing means for managing management information of a document. The document management program 27 allows a computer to realize a document managing function using the document management table 25.

As shown in FIGS. 7, 8, and 9, in the document management table 25, an order, document ID, state, page number, document date, file name, color ID and the like are stored as the management information on the document.

Information indicating a display order of each document is stored as the order. As described above, the respective documents are displayed in order of time series based on the document time in the document searching screen 40 shown in FIG. 3. Therefore, the order of each document is manufactured in a descending order of the document time in the document management table 25.

As the document ID, unique ID information is stored which is applied to each document in such a manner as to identify each document.

As the state, information is stored which indicates a processed state of each document is stored. For example, information indicating an “updated” state or a “completed” state is stored. The “completed” state indicates that the update (update or new registration) of the document has been completed. The “updated” state indicates that the document is waiting for the update (update or new registration).

As the page number, information is stored which indicates the page number of the document. The page number is determined, when the document is brought into the “completed” state.

As the document time, preparation or update time is stored with respect to each document. For example, as the document time, the update time is stored with respect to the file corresponding to the document managed in the first file management table 23.

As the file name, information is stored which indicates the file corresponding to the document. For example, as the file name, a drive name, folder name, and file name are stored with respect to the file corresponding to each document.

As the color ID, information is stored which indicates a color for displaying the information indicating each document. The color ID is unique ID information applied to each color for identifying the color. It is to be noted that the color management table 26 shows information indicating an actual color corresponding to the color ID.

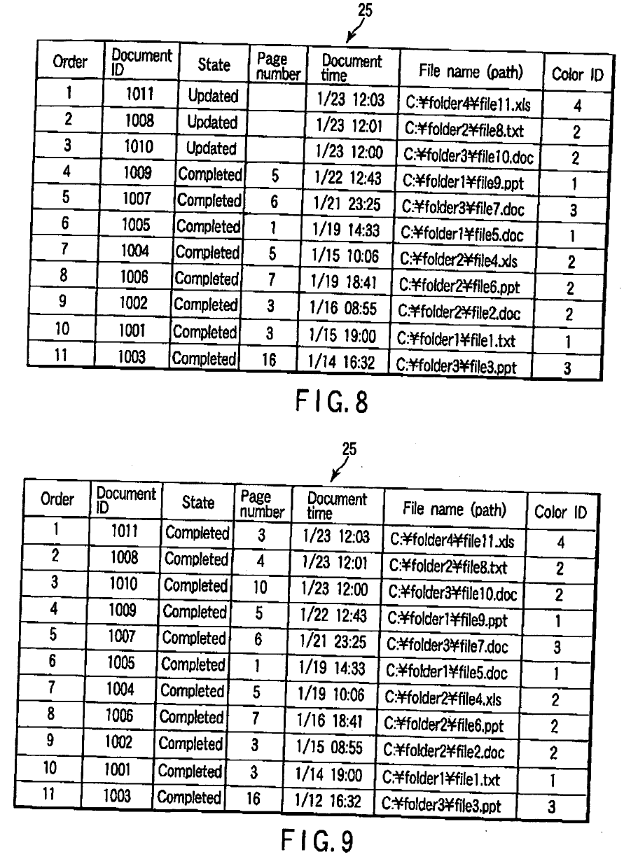

Moreover, the document management table 25 is updated by registration of the document management information described later. For example, nine documents are managed in the document management table 25 shown in FIG. 7. It is assumed that the document having document ID “1008” is updated, and documents having document IDs “1010” and “1011” are newly added in this state. In this case, in the registration of the document management information described later, three documents (document IDs “1008”, “1010”, “1011”) whose states have been set to be “updated” are registered in the document management table 25 shown in FIG. 7. In this case, the document management table 25 is prepared as shown in FIG. 8.

Furthermore, in the document management table 25 shown in FIG. 8, three documents having document IDs “1008”, “1010”, “1011” are brought into the “updated” states, and stored. As to the document set to the “updated” state in the document management table 25, images are successively produced as described later. When this image production is completed, the state of the document is rewritten into the “completed” state. Therefore, when the image production is completed with respect to three documents having the document IDs “1008”, “11010”, “1011”, the document management table 25 shown in FIG. 8 is rewritten into that shown in FIG. 9.

It is to be noted that the number of pages of each document is determined by the number of images produced by the image production described later. Therefore, in the document management table 25, as shown in FIG. 8, page number columns of the respective documents brought into the “updated” states are blank. When the “updated” state of the document is changed into the “completed” state, as shown in FIG. 9, the number of images produced by the image production described later is stored as the page number,

Next, the color management table 26 will be described.

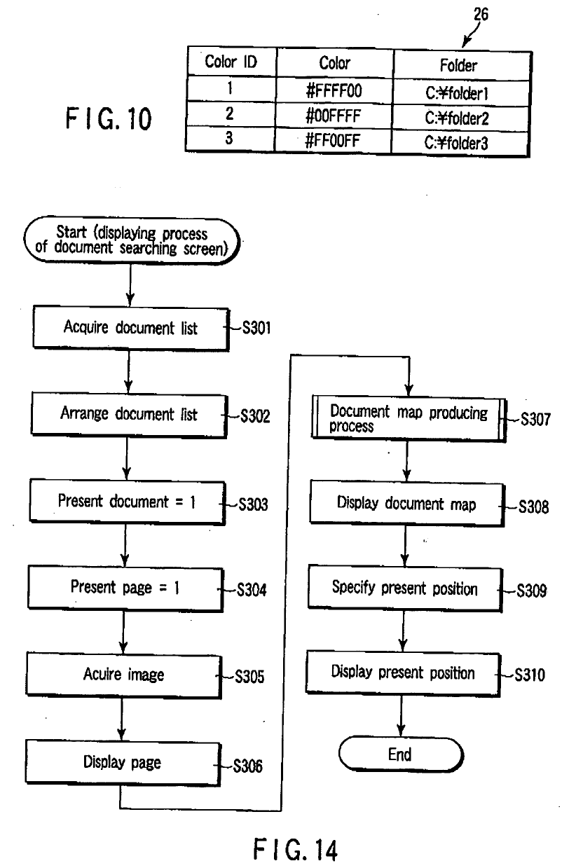

FIG. 10 is a document map showing a constitution example of the color management table 26.

In the color management table 26, the color ID, color (information indicating the actual color), and folder are associated. As described above, the color associated with each document is represented by the color ID in the document management table 25. Therefore, the color corresponding to each document is judged by the color ID of the document management table 25 and the color of the color management table 26. It is to be noted that the color associated with each document is the color of the bar corresponding to each document displayed in the document map 42 of the document searching screen 40.

Moreover, as described above, in the present embodiment, the color of the bar corresponding to each document displayed in the document map 42 of the document searching screen 40 is set for each folder. Therefore, in the color management table 26, as shown in FIG. 10, the color ID and the color are shown corresponding to each folder. It is to be noted that to set the color of the bar corresponding to each document displayed in the document map 42 for each extension of the file or each application for opening the document, in the color management table 26, the color ID and the color are stored corresponding to each extension or application.

Next, the registration of the document management information will be described in the document managing apparatus 1.

FIG. 11 is a flowchart showing a registering process or the document management information in the document managing apparatus 1.

First, to start the document managing apparatus 1, that is, to start the program 27 for document management by a PC which is the document managing apparatus 1, the CPU 11 first reads as previous file information the first file management table 23 in the HDD 15 (step S101). When the first file management table 23 is read, the CPU 11 reads as present file information the second file management table 24 in the HDD 15 (step S102).

On reading the first and second file management tables 23, 24, the CPU 11 performs a difference file detecting process to detect a difference between the management information (previous file information) of all files stored in the first file management table 23 and that (present file information) of all the files stored in the second file management table 24 (step S103). The information indicating a difference file detected by the difference file detecting process is temporarily stored, for example, as a list of difference files in the RAM 12 or the like. It is to be noted that the step S103 corresponds to detecting means for detecting updated files such as a file whose contents have been updated and a newly added file, and is a detecting function realized by the document management program 27.

The difference file detecting process is a process to extract a file updated between a preparation time of the previous file information and the present time, or a newly added file. It is to be noted that the access time is not assumed as an object to be detected as the difference file in the present embodiment. That is, the file which does not exist in the previous file information but which exists in the present file information, that is, the tile existing only in the second file management table 24 is judged as the newly added file.

Moreover, the file whose update time in the present file information is different from that in the previous file information, that is, the file having the different update time in the first and second file management tables 23, 24 is judged as the updated file.

It is to be noted that the file which does not exist in the present file information but which exists in the previous file information, that is, the file existing only in the first file management table 23 is judged as a deleted file.

For example, a detecting process of the difference file by the first file management table 23 shown in FIG. 5 and the second file management table 24 shown in FIG. 6, three files having file names “file8.txt”, “file10.doc”, “file11.xls” are detected as the difference files.

In this case, as to the file (file name “file8.txt“) whose path is “C:\folder2\file8.txt”, the update date differs. Therefore, the file having the file name “file8.txt” is judged as the updated file.

The file (file name “file10.doc”) whose path is “C:\folder3\file10.doc”, and the file (file name “file11.xls”) whose path is “C:\folder4\file11.xls” exist only in the second file management table 24. Therefore, the files whose file names are “file10.doc” and “file11.xls” are judged as newly added files.

When the difference file is detected by the above-described difference file detecting process (step S104, YES), the CPU 11 successively reads out the management information of the detected difference file (step. S105). The CPU 11 repeatedly executes the process of steps S105 to S127 until the process is completed with respect to all the difference files detected by the difference file detecting process.

That is, the CPU 11 reads out management information of one difference file in the step S105 to thereby acquire information on one difference file (step S106). Here, the information on the difference file is acquired including a type of the difference file, classification of the difference file and the like. Specifically, examples of the type of the difference file include information indicating a format form of the file. The classification of the difference file is, for example, information indicating the folder in which the file is stored.

When the information indicating the type is acquired as the information on the difference file, the CPU 11 judges whether or not the difference file is a file of image data (step S107). For example, it is judged by the format form of the difference file whether or not the difference file is the file of image data. In this case, the CPU 11 acquires the information indicating the format form of the difference file as the information indicating the type of the difference file (step S106), and judges whether or not the format of the acquired difference file is a format of an image to thereby judge whether or not the difference file is the file of the image data (step S107).

It is to be noted that the step S107 corresponds to judging means for judging whether or not the detected difference file is the file of the image data, and is a judging function realized by the document management program 27.

When it is judged by the judgment that the difference file is the file of the image data (step S107, YES), the CPU 11 judges whether or not the difference file is classified and stored as the image (step S108). For example, it is judged whether or not the folder (storage folder) in which the difference file is stored is a folder (image folder) in which mainly the file of the image data is stored to thereby judge whether or not the difference file is classified and stored as the image.

In this case, the CPU 11 acquires information indicating the storage folder of the difference file as the information indicating the classification of the difference file (step S106). The CPU judges whether or not the acquired storage folder of the difference file is the image folder to thereby judge whether or not the difference file is classified and stored as the image (step S108).

Moreover, the present embodiment will be described assuming that a folder in which a half or more of a plurality of stored files are image data files (image format files) is an image folder. In this case, for example, it is judged whether or not the half or more of the files in the folder are the image data files to thereby judge whether or not the storage folder is the image folder. A folder in which a plurality of image data files is stored may be assumed as the image folder. In this case, for example, it is judged whether or not a plurality of image data files (i.e., image data files other than the difference file) is stored in the folder to thereby judge whether or not the storage folder is the image folder.

When it is judged by the judgment that the difference file is classified and stored as the image (step S105, YES), the CPU 11 performs an image combining process to combine all the image data files that are stored in the storage folder of the difference file (step S110).

That is, when the difference file is the image data file classified and stored as the image, that is, when the difference file is the image stored in the image folder (YES in the steps S107 and S108), the CPU 11 performs the image combining process in the storage folder of the difference file (step S110).

It is to be noted that the step S110 corresponds to combining means for combining the image data files stored in the same classification in storage means, and is a combining function realized by the document management program 27.

In this image combining process, the files of the image data stored in the storage folder of the difference file are combined to produce a combined file. It is to be noted that the image combining process will be described later in detail. When the combined file is produced by the image combining process, the CPU 11 advances to step S121 described later to perform a document management information registering process (updating process of the document management table 25) for registering the produced combined file as the document (steps S121 to S127). It is to be noted that the information on the combined file produced by the image combining process is stored in the second file management table 24.

When the difference file which is a processing object is not an image data file (step S107, NO), or when the difference file is not classified or stored as the image (step S108, NO), the CPU 11 omits the image combining process, and advances to the step S121 described later to perform a document management information registering process (updating process of the document management table) for registering the difference file as the document (steps S121 to S127).

That is, in the registering process (updating process of the document management table) of the document management information with respect to the file to be registered as the document (the difference file or the combined file produced by the image combining process), the CPU 11 first judges whether the file to be registered as the document is an updated file (file whose update time has been changed) or a newly added file (step S121). For example, when the combined file is produced based on the image data file (difference file) added to the existing folder, the file is judged as the updated file. When the combined file is produced based on the image data Rile (difference file) stored in a new folder, the file is judged as the newly added file.

When it is judged by the above-described judgment that the file to be registered as the document is the updated file (step S121, YES), the CPU 11 updates the management information of the document corresponding to the file in the document management table 25 (step S122).

When it is judged by the above-described judgment that the file is not the updated file, that is, when it is judged that the file is the newly added file (step S121, YES), the CPU 11 judges whether or not the file is stored in a newly prepared folder (new folder) (step S122). In this judgment, it is judged whether or not the folder in which the file is stored is a folder in which the color is managed by the color management table 26 to thereby judge whether or not the folder is a new folder. That is, the folder whose color is set in the color management table 26 is judged as the existing folder.

For example, as to the file whose path is “C:\folder3\file10.doc”, the color is already assigned to the folder “C:\folder3” in the color management table shown in FIG. 10. In this case, it is judged that the folder “C:\folder3” is not a new folder. On the other hand, as to the file whose path is “C:\folder4\file11.xls”, any color is not assigned to the folder “C:\folder4” in the color management table shown in FIG. 10. In this case, it is judged that the folder “C:\folder4” is a new folder.

When it is judged that the folder is the new folder (step S123, YES), the CPU 11 produces the color to be assigned to the new folder (step 124). For example, it is assumed that a new color that is not assigned to any other folder is assigned to the new folder. A unique color ID is assigned to the produced color. On producing the color to be assigned to the new folder, the CPU 11 adds, to the color management table 26, the color information in which the color is associated with the color ID as the color information with respect to the new folder (step S125).

On adding the color information with respect to the new folder in which the difference file is stored, the CPO 11 performs a new document adding process to add to the document management table 25 the management information of the document corresponding to difference file (step S126).

Moreover, when it is judged that the folder is not the new folder (step S123, NO), by the color management table 26, the CPU 11 acquires the color ID to be assigned to the folder in which the file is stored (step S127). In this case, the CPU 11 performs the new document adding process to add to the document management table 25 the management information of the document corresponding to the difference file (step S126).

Furthermore, in the new document adding process of the step S126, the management information of the document corresponding to the newly added file is produced with reference to the second file management table 24 and the color management table 26.

For example, information described later is used as the management information of the document registered in the document management table 25. The update time of the file is used in the document time in the management information of the document. Time information set by a time setting process described later is used as to the combined file produced by the image combining process. The path of the file is used in the file name in the management information of the document. As to the combined file produced by the image combining process, for example, a file name is given based on the folder name of the storage folder of the respective combined files. Newly produced unique information is used in the document ID in the management information of the document in such a manner as to be distinguished from the existing document. In the color ID in the management information of the document, the color ID of the color is used, this color being associated with the folder in which the difference file is stored. Additionally, a page number is not set in the management information of the document, and the state is set to be “updated” in the management information of the document. Accordingly, the page number of the document in the document management information is determined based on the number of the image data of the file produced by the image producing process described later.

Additionally, in a case where the difference file is not detected by the difference file detecting process, or the process is completed with respect to all the difference files detected by the difference file detecting process (step S104, NO). The CPU 11 stores in the first file management table 23 the information stored as file information at this starting time in the existing second file management table 24 (step S128). Therefore, in the first file management table 23, file memory is stored in performing the difference file detecting process (this starting time). Accordingly, the information stored in the first file management table 23 is used as the previous file information the next starting time.

In the above-described registering process of the document management information, the updated files are detected like the file whose contents have been updated or the newly added file. As to the image data file classified and stored as the image in the image folder among the detected files, the file is combined with a plurality of image data files stored in the image folder to form the combined file, and the file is registered as the document in the document management table 25.

Accordingly, as to the image data file stored in the image folder among the updated files, the file is combined with the other image data files stored in the image folder, and stored as the document. That is, the files of a plurality of image data stored in one image folder can be put together into one document and registered. As a result, when a specific document or image data is searched, the user easily searches for the desired image data, and a searching efficiency of the document or image data is enhanced.

Next, the image combining process of the step 3110 will be described.

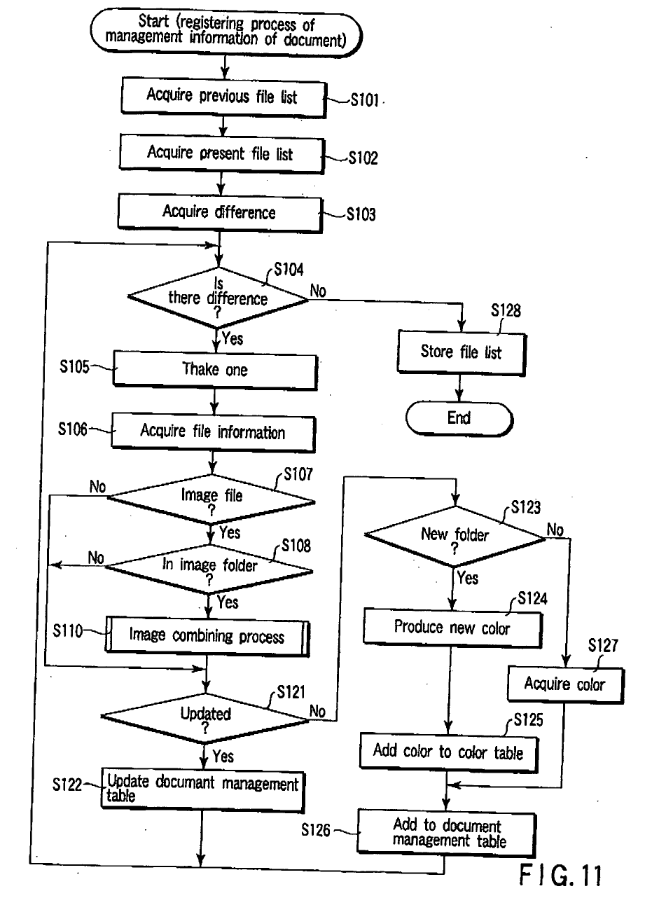

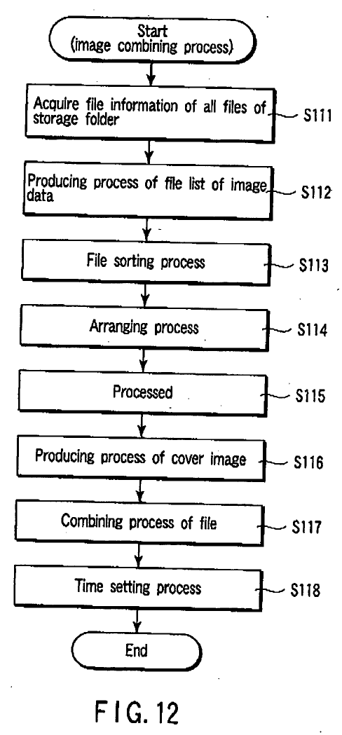

FIG. 12 is a flowchart showing the image combining process in the step S110.

That is, in a case where the difference file which is a processing object is the image data file classified and stored as the image, that is, when the difference file is the image stored in the image folder (YES in steps S107 and S108), the CPU 11 performs an image combining process to combine the image data files in the image folder which is the storage folder of the difference file.

In the image combining process, the CPU 11 first acquires the file information with respect to all the files stored in the storage folder judged to be the image folder (step S111).

Here, the file information of the respective files are acquired including: information (format information) for producing a file list of image data in step S112; information (display size information) for sorting the file in step S113; information (file name, time information, format information and the like) for arranging the files in step S114; information (folder name) for producing a display image in step S116; information (update time information) for the time setting process in the step S118 and the like.

On acquiring the file information of all the files stored in the storage folder of the difference file, the CPU 11 extracts the files of all the image data stored in the storage folder based on the acquired file information, and produces a list of the extracted image data files (step S112).

On producing a list of the entire image data files stored in the storage folder, the CPU 11 performs a sorting process to select the image data files having an equal display size among the respective image data files (step S113). This is a process for sorting the image data files to be integrated as one document. Therefore, when the images having different display sizes are integrated into one document, the step S113 may be omitted.

It is to be noted that the step S113 corresponds to sorting means for sorting the files, and is a sorting function realized by the document management program 27.

Moreover, in the step S113, the image data files to be integrated as one document may be sorted based on a condition other than the display size. For example, there is a plurality of types of formats in the image data. Therefore, the image data files in the storage folder may be sorted for each format. In this case, the only image data having the same format can be integrated as one document when information indicating relevance is imparted to a part of the file name, the image data files in the storage folder may be sorted for each file name. In this case, the image data files having the relevance to one another based on the file name can be integrated into one document.

On sorting the image data files to be integrated into one document by the sorting process, the CPU 11 performs an arranging process to arrange all the sorted files based on a predetermined condition like the file name (step S114). The arranging process is a process for determining the page number with respect to each image data file. Therefore, the page number is assigned to each file image in order of arrangement by the arranging process. The respective files may be arranged based on the file names of the respective files or arranged based on the time information (preparation time or update time) of each file.

On arranged the respective sorted files, the CPU 11 judges that all the sorted files have been processed (step S115). Here, as to the file detected as the difference file in the step S103 among the respective sorted files, the file is deleted from the difference file list. That is, the step S115 prevents the files combined in step S116 described later from being judged as processing objects again.

When all the sorted files are judged to be processed, the CPU 11 performs a cover producing process to produce an image for use as a cover (step S116). In this cover producing process, an image (image data file) is produced for use as the cover of one document into which all the sorted image data files are integrated.

It is to be noted that the step S116 corresponds to cover producing means for produced the cover image, and is a cover producing function realized by the document management program 27.

For example, when the image of the first page of each document is used as the representative image, the image produced by the cover produced process is used as the image of the first page of the document. That is, in the cover producing process, when the document is switched in a document searching process described later (the document is searched using a mouse wheel or the like), the information displayed in the display 17 is produced as a representative image of the document. For example, as the cover image produced by the cover producing process, an image is produced which indicates information indicating a folder name, information identifying the image document or the like.

On producing the cover image by the cover producing process, the CPU 11 disposes the produced display image in a top (image of a first page), and performs a file combining process to successively combine the respective arranged file images (step S117). That is, in the file combining process, a combined file is produced in such a manner as to manage as one document the respective files sorted in the step S113 and the cover image file produced in the step S116. It is to be noted that the information on the produced combined file is stored in the second file management table 24.

Moreover, in the file combining process, the cover image produced in the step S116 is used as the first page, and the respective files sorted in the step S113 are used as the respective pages in order arranged in the step S114. Therefore, in the combined file produced by the file combining process, the first page corresponds to the display image, and the second and subsequent pages correspond to the respective file images in the arranged order.

On combining the display image file with the respective sorted files to produce the combined file by the file combining process, the CPU 11 performs the time setting process to set the time information to the combined file (step S118). In this time setting process, the time information is set to the combined file based on the time information of the respective files combined by the combining process. For example, among update times of the respective files sorted by the sorting process, a latest update time is set as the update time of the combined file.

It is to be noted that the step S118 corresponds to time setting means for setting time information of one document comprising a plurality of combined files, and is a time setting function realized by the document management program 27.

As described above, in the image combining process, the image data file detected to be updated is combined with another image data file stored in the storage folder of the files. Accordingly, it is possible to manage as one document the updated image data file and the other image data file existing in the storage folder of the files.

Next, the document image producing process will be described.

In the registering process of the document management information, the management information of the documents corresponding to the updated file and the newly registered file, respectively, are registered as the information having the “updated” state in the document management table 25. The file having the “updated” state indicates that an image for display is not produced. Therefore, as to a document whose “state” is “updated”, the image for display needs to be produced. This process to produce the image for display of the document is referred to as the image producing process.

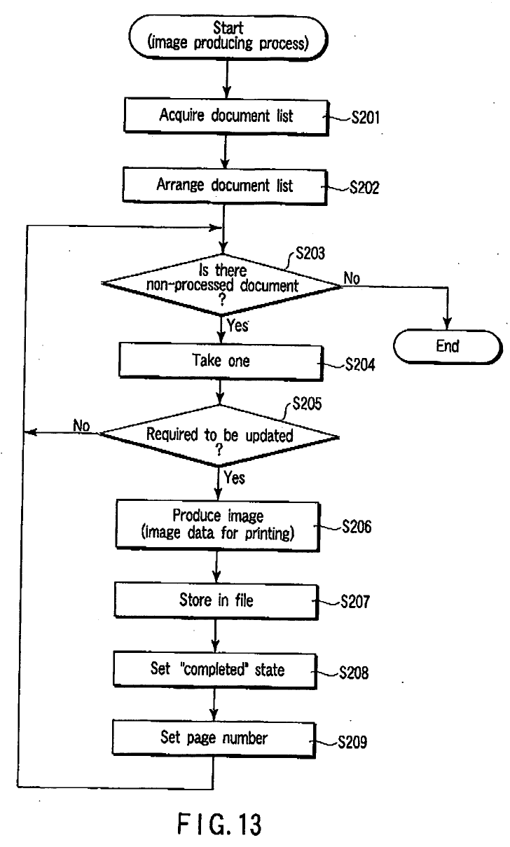

FIG. 13 is a flowchart showing an image producing process in the document managing apparatus 1.

That is, when the above-described registering process is completed with respect to the document management information, the CPU 11 performs the image producing process to produce an image for display. When the image producing process is started, the CPU 11 reads the management information of all documents from the document management table 25 (step S201). On reading the management information of the document from the document management table 25, the CPU 11 arranges the management information of all the documents based on the document time in the management information of each document (step S202). Accordingly, in the document management table 25, the management information of all the documents is rearranged in order of document time (in order of time series). For example, in the example shown in FIG. 8, three newest documents are brought into the “updated” state,

On arranging the management information of the document in the document management table 25 based on the document time, the CPU 11 judges whether or not the document (non-processed document) exists which is not subjected to the image producing process (step S203). When it is judged in this judgment that the non-processed document exists, the CPU 11 reads out the management information of the non-processed document every document (step S204). At this time, the CPU 11 first reads out a new time series document.

On reading out the management information of one non-processed document, the CPU 11 judges whether or not the “state” is “updated” in the management information of the read document (step S205). When it is judged by the judgment that the “state” is “updated” (step S205, YES), the CPU 11 produces the image for display of the document (step S206).

It is to be noted that in this image producing process, a bitmap image is produced with respect to each page constituting the document as the image for display of the document. It is assumed in the present embodiment that image data for display of the document is prepared as image data for printing. The data of each document is formed in various forms such as text data and image data.

In the document managing apparatus 1, a document constituted of various modes of data is regarded as a management object. Therefore, in the document managing apparatus 1, data of each page constituting the document is produced as the image data for printing. As to the data having various forms used in various application programs, an image for printing is usually prepared in the application program. For example, when the document is the text data, the image for display of the document is produced, for example, as the image for printing by the application program of a word processor.

When the image data for printing is produced by this image producing process, the CPU 11 stores the image (image data for display of each page) of each page constituting the document as the file of the image data in the HDD 15 (step S207). Accordingly, the file of the image data as many as the pages of the document is stored in the HDD 15. On storing in the HDD 15 the file of the image data of each page of the document, the CPU 11 changes the “state” to the “completed” state in the management information of the document of the document management table 25. Furthermore, the CPU 11 specifies the page number from the file number produced as the image data, and sets the page number as the management information of the document in the document management table 25 (step S209).

Moreover, when there is not any non-processed document any more, that is, the “state” of all of the documents in the document management table 25 is set to be “completed” (step S203, NO), the CPU 11 ends the image producing process.

As described above, in the present embodiment, the image data for display of each document is produced as one file for each page of the document. The image data for display of each document may have any form such as TIF, PDF. A JPEG form is used in the present embodiment.

Additionally, as to each file of the image data for display, which is an image of each page, the file name can be specified from the document ID and the page number. For example, the file of the image data for display is stored with a file name “document ID page number.jpg”.

For example, it is assumed that the document of “C:\folder4\file11.xls” comprises three pages of images in the document management table 25 shown in FIG. 8. In this case, in the producing process of the image for display concerning the document “C:\folder4\file11.xls”, the image data for display of three pages (file of three image data having the JPEG form) is produced.

Moreover, as to the document “C:\folder4\file11.xls”, as shown in FIG. 8, the document ID is “1011”. Therefore, as the image data for display of the document “C:\folder4\file11.xls”, three files having file names “1011-001.jpg”, “1011-002.jpg”, and “1011-003.jpg” are produced.

In this case, in the management information of the document whose document ID is “1011” in the document management table 25 shown in FIG. 8, as shown in FIG. 9, the “state” is set to be “completed”, and the “page number” is set to “3”. It is to be noted that FIG. 9 shows an example of the document management table 25 in a case where the image producing process is completed with respect to the document management table 25 having the state shown in FIG. 8.

It is to be noted that the image producing process may be executed in parallel with another process. That is, the image producing process may be executed in background of another process. For example, when there are many documents having the “updated” state, or there are many pages in the document whose “state” is “updated”, there is a possibility that much time is required for the image producing process. Therefore, even if the image producing process is being executed, the CPU 11 may perform a displaying process or the like of the document searching screen 40 described later.

Next, a displaying process will be described in a case where the document searching screen 40 (display window for document searching) is displayed.

FIG. 14 is a flowchart showing a displaying process of the document searching screen 40.

First, to display (start) the document searching screen 40, the CPU 11 first reads management information of all the documents stored in the document management table 25 (step S301). On reading the management information of all the documents stored in the document management table 25, the CPU 11 arranges the management information of all the read documents in order (in order of time series) from a latest document time (step S302).

When the management information of all the documents is arranged in order of time series, the CPU 11 secures, for example, a storage region for a present document (displayed document) which stores information indicating the present displayed document on the RAM 12. On securing the storage region of the present document, the CPU 11 sets information indicating a newest document in the storage region for the present document (step S303). Here, it is assumed that an “order” in which the document is stored as the management information in the document management table 25 is is set as the information indicating the present document in the storage region of the present document. In other words, the CPU 11 indicates the presently displayed document (present document) by the “order” given to each document.

Furthermore, the CPU 11 secures, for example, a storage region for a present page (displayed page) which stores information indicating the presently displayed page number of the document on the RAM 12. On securing the storage region of the present page, the CPU 11 sets information indicating a representative page (first page in the present embodiment) in the storage region for the present page (step S304). Here, it is assumed that the page number is set as the information indicating the present page in the storage region of the present page.

That is, the CPU 11 displays the representative page (first page) of the newest document as an image of initial display. Therefore, the CPU 11 sets the present document as “1”, and sets the present page as “1”. On setting the present document to “1” and the present page to “1”, the CPU 11 acquires the file of the image data for display of the page (image of the page “1” in the document having the order “1”) (step S305).

In this image acquiring process, the file of the image data of the page to be displayed is specified with reference to the document management table 25. That is, the CPU 11 acquires the document ID corresponding to the “order” (“1” in this case) set as the present document with reference to the document management table 25. On acquiring the document ID of the present document, the CPU 11 specifies the file of the image data constituted of the document ID of the present document and the page number by the “page number” (“1” in this case) set as the specification.

For example, in the example of the document management table 25 shown in FIG. 9, the document ID having the “order” “1” is “1011”. In this case, the image file of the first page of the document ID “1011” is stored with the name “1011-001.jpg”. Therefore, when the present document is set as “1”, and the present page is set as “1”, the CPU 11 specifies “1011-001.jpg” as the file of the image data with reference to the document management table 25 shown in FIG. 9.

On acquiring the file of the image data by the above-described image acquiring process, the CPU 11 displays the image data of the file in the image display region 41 of the document searching screen 40 (step S306). On displaying the image data of the acquired file in the image display region 41, the CPU 11 performs a document map producing process to produce the document map 42 stacked/displayed based on the order (order of the document time of each document in the present embodiment) of all the documents (step S307). This document map producing process will be described later in detail.

On producing the document map 42 by the document map producing process, the CPU 11 displays the produced document map 42 in a predetermined display region in the document searching screen 40 (step S308). On displaying the document map 42 in the document searching screen 40, the CPU 11 specifies the position of the present document in the document map 42 (step S309). On specifying the position of the present document, the CPU 11 displays the pointer 43 indicating the position of the present document in the document map 42 (step S310).

By the above-described displaying process of the document searching screen, an initial screen is displayed as the document searching screen 40 in the display window in the display 17.

Next, the document map producing process will be described.

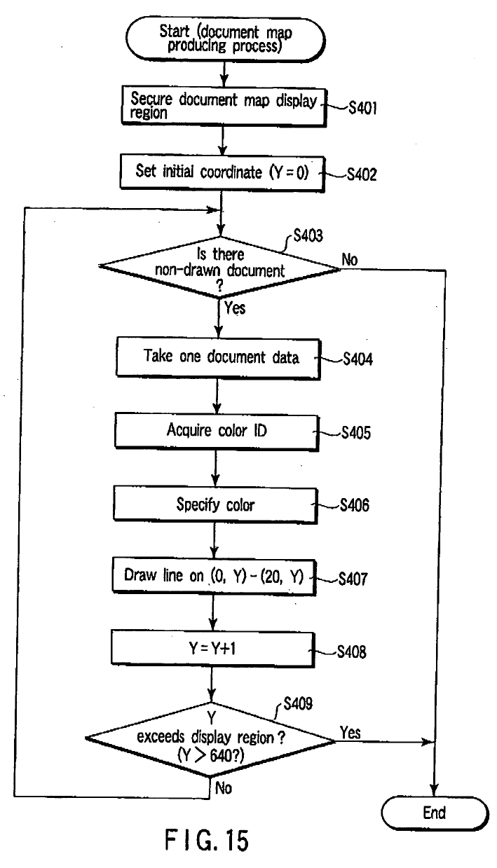

FIG. 15 is a flowchart showing the document map producing process.

On starting the producing process of the document map 42, the CPU 11 secures a display region for displaying the document map 42 in the document searching screen 40 (step S401). It is assumed that the display region of the document map 42 is set beforehand. In the step S401, it is assumed that the CPU 11 displays the secured display region of the document map 42 in a color which is an initial value, such as white.

For example, as shown in FIG. 3, the display region of the document map 42 is set as a right-end region of the document searching screen 40, which is sized in such a manner as to have a width of 20 pixels and a height of 640 pixels. It is to be noted that here, as shown in FIG. 3, the display region of the document map 42 is a rectangular region represented by coordinate value (X, Y) including four points (0, 0), (20, 0), (0, 640), (20, 640). It is to be noted that in the present embodiment, a Y-direction is defined as a vertical direction and an X-direction is defined as a lateral direction in the document searching screen shown in FIG. 3.

On securing the display region of the document map 42 in the document searching screen 40, the CPU 11 sets an initial coordinate value to start drawing (step S402). Here, as to the initial coordinate value, it is assumed that a Y-coordinate is set to “0” (Y=0) as an uppermost end of the display region of the document map 42.

On setting the initial coordinate value, the CPU 11 reads out the management information of the document from a small “order” in order from the document management table 25. That is, the CPU 11 judges whether or not a document (non-drawn document) whose bars are not drawn in the display region of the document map 42 exists in the document management table 25. When it is judged by this judgment that there is the non-drawn document in the document management table 25 (step S403), the CPU 11 reads out the management information of the document having a smallest “order” among the non-drawn documents (step S404).

On reading the management information of the document, the CPU 11 specifies the color ID assigned to the read document (step S405). On specifying the color ID of the document, the CPU 11 determines the actual color corresponding to the color ID of the document with reference to the color management table 26 (step S406). Accordingly, the determined color is a color in which the bar (line) indicating the document is drawn in the document map 42.

On judging the color in which the bar indicating the document is drawn, the CPU 11 draws the bar (line) indicating the document in the determined color in the present coordinate value in the display region of the document map 42 (step S407). Here, it is assumed that the bar indicating each document is a line having a width (height) for one pixel in the Y-direction. In this case, as to the first document, the bar having the width (height) for one pixel is drawn in the initial coordinate value ((0, Y) to (20, Y)) of Y in the display region of the document map 42.

On drawing the bar indicating the document, the CPU 11 sets “Y=Y+1” to thereby increase the coordinate value in the Y-direction by one pixel (step S408). When the coordinate value in the Y-direction is increased by one pixel, the CPU 11 judges whether or not the coordinate value in the Y-direction exceed the display region of the document map 42. When it is judged by this judgment that the coordinate value of the Y-direction exceeds the display region of the document map 42 (step S409, YES), the CPU 11 ends the producing process of the document map 42.

Moreover, when it is judged by this judgment that the coordinate value of the Y-direction does not exceed the display region (step S409, NO), the CPU 11 returns to the step S403. Accordingly, the CPU 11 repeatedly executes the above-described steps S403 to S409 until there is not any more non-drawn document in the display region of the document map 42. That is, the process in the steps S403 to S409 is repeatedly executed with respect to all the documents managed by the document management table 25. *By the above-described process, the document map 42 is produced in which the bars indicating the respective documents displayed in the color corresponding to each document are stacked/displayed in the vertical direction (Y-direction) in the document searching screen 40 in the “order” (“order” based on the document time of each document) of each document managed by the document management table 25.

Next, a document searching process will be described.

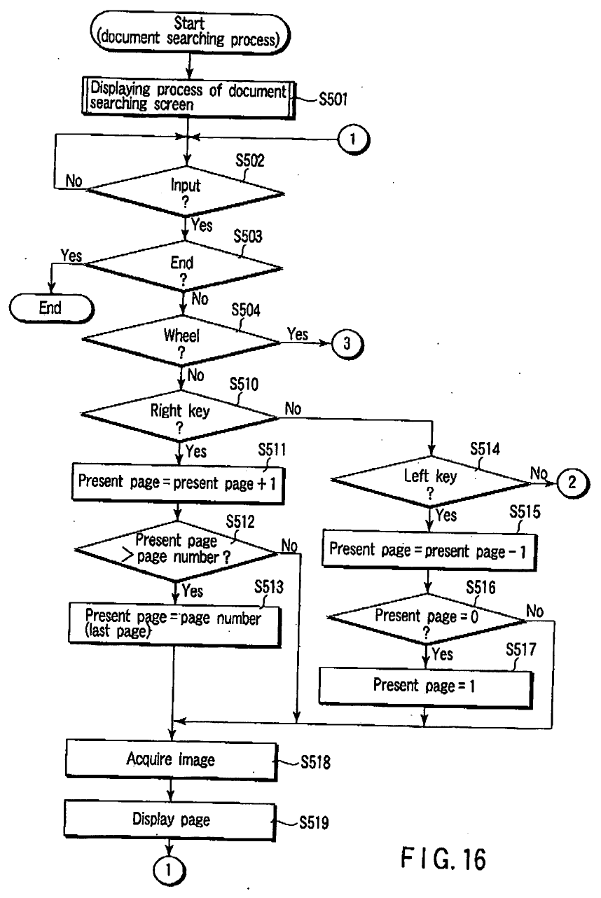

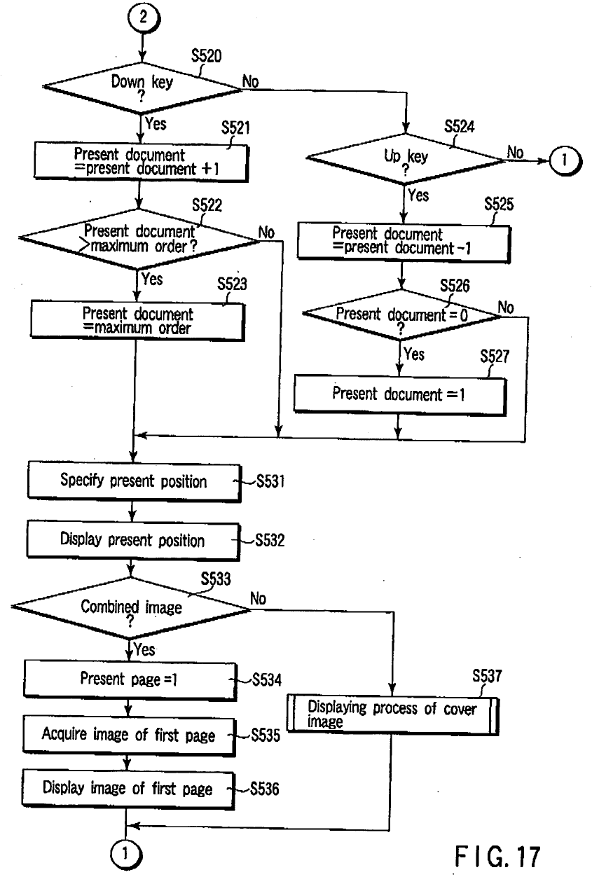

FIGS. 16, 17, 18 are flowcharts showing the document searching process.

First, it is assumed that the display 17 displays the document searching screen 40 displaying the image of the first page of the document having a latest document time by the above-described displaying process of the document searching screen (step S501). Since the process of the step S501 is similar to that of FIG. 13, description and flowchart of a sub-flow are omitted.

In this state, the CPU 11 waits for an input from a user by the mouse 19 or the keyboard 21 (step S502). In this state, the CPU 11 detects presence of an input into the mouse 19 or the keyboard 21. As to the input into the wheel 34 of the mouse 19, a rotation amount of the wheel 34 in a predetermined time is input as a fluctuation amount. As to the inputs into the respective keys of the keyboard 21 or the right/left buttons 32, 33, the key which has been input is detected.

On detecting the input into the mouse 19 or the keyboard 21 (step S502, YES), the CPU 11 judges whether or not input instruction contents indicate an instruction for end (step S503). When it is judged by this judgment that the input instruction contents indicate the instruction for the end (step S503, YES), the CPU 11 deletes the document searching screen 40 to end the process.

Moreover, when it is judged by the judgment that the input instruction contents do not indicate the instruction for the end (step S503, NO), the CPU 11 judges whether or not the input instruction contents indicate the input into the wheel 34 of the mouse 19 (step S504).

When it is judged that there is not any input into the wheel 34 of the mouse 19 (step S504, YES), the CPU 11 judges the input into the right key instructing movement to the right (step S510), the input into the left key instructing movement to the left (step S514), the input into the down key instructing downward movement (step S520), or the input into the up key instructing upward movement (step S524). It is to be noted that when the input is made into a key other than the right, left, down, and up keys, the CPU 11 returns to the step S502, and again waits for the input.

That is, when it is judged that there is an input into the right key (step S510, YES), the CPU 11 increases the present page by one to set “present page=present page+1” (step S511). In this case, the CPU 11 acquires the page number of the present document from the document management table 25, and judges whether or not the present page set in the step S511 exceeds the page number of the present document (step S512). When it is judged that the present page set in the step S511 exceeds the page number of the present document, the CPU 11 judges the present page as the page number of the present document, that is, the last page of the present document (step S513).

Moreover, when it is judged that there is an input into the left key (step S514, YES), the CPU 11 decreases the present page by one to set “present page=present page−1” (step S515). In this case, the CPU 11 judges whether or not the present page to be displayed is “0” (step S516). When it is judged that the present page set in the step S515 is “0”, the CPO 11 sets the present page to “1”, that is, the first page of the present document (step S517).

When the present page is changed by the steps S510 to S517, the CPU 11 acquires the document ID of the present document by correspondence between “order” and “document ID” in the document management table 25. On acquiring the document ID of the present document, the CPU 11 acquires the file of the image of the page by the document ID and the present page of the present document (step S518). On acquiring the file of the image of the page, the CPU 11 displays the image of the page in the image display region 41 of the document searching screen 40 (step S519).

Furthermore, when it is judged that there is an input into the down key (step S520, YES), the CPU 11 increases the present page by one to set “present document=present document+1” (step S521). In this case, the CPU 11 acquires a maximum order (“order” of the document having an oldest document time) from the document management table 25, and judges whether or not the present document set in the step S521 exceeds the maximum order (step S522). When it is judged here that the present document set in the step S521 exceeds the maximum order, the CPU 11 judges the document having the maximum order, that is, the oldest document time as the present document (step S523).

Moreover, when it is judged that there is an input into the up key (step S524, YES), the CPU 11 decreases the present document by one to set “present document=present document−1” (step S525). In this case, the CPU 11 judges whether or not the present document set in the step S525 is “0” (step S526). When it is judged that the present document set in the step S525 is “0”, the CPU 11 sets the document page to “1”, that is, the document having the latest document time (step S527).

When the present document is changed by the steps S520 to S527, the CPU 11 specifies the position of the present document in the document map 42 of the document searching screen 40 (step S531). When the position of the present document is specified, the CPU 11 displays the pointer 43 indicating the position of the present document in the document map 42 (step S532). That is, in the step S532, the CPU 11 changes the position of the pointer 43 in the document searching screen 40 to a position indicating the present document in the document map 42 specified in the step S531.

Moreover, when the present document is changed in the steps S520 to S527, the CPU 11 judges whether or not the present document is a document produced by combining a plurality of image data files (step S533). That is, the CPU 11 judges whether or not the file which is the present document is the combined file produced by the image combining process.

When it is judged by this judgment that the present document is not produced by combining the plurality of image files (step S533, NO), the CPU 11 sets the present page to “1” which is the representative page of the document (step S534). When the present document and the present page are set by the above-described process, the CPU 11 acquires the document ID of the present document by correspondence between “order” and “document ID” in the document management table 25. On acquiring the document ID of the present document, the CPU 11 acquires the image file of the page by the document ID of the present document and the present page (step S535). On acquiring the page image file, the CPU 11 displays the page image in the image display region 41 of the document searching screen 40 (step S536).

Moreover, when it is judged by the judgment that the present document is obtained by combining a plurality of image files (step S533, YES), the CPU 11 performs a cover image displaying process to display the cover image of the document (cover image produced in the step S116 of the above-described image combining process) (step S537). The displaying process of the cover image will be described later in detail.

It is to be noted that the process of the steps S533 to S537 may be performed in parallel with the process of the steps S531 and S532.

Additionally, when it is judged in the above-described judgment that there is an input into the wheel 34 of the mouse 19 (step S504, YES), the CPU 11 performs a document searching process in accordance with the rotation amount of the wheel 34 of the mouse 19.

That is, when it is judged in the judgment that there is an input into the wheel 34 of the mouse 19 (step S504, YES), the CPU 11 acquires the rotation amount of the wheel 34 within a predetermined time as a fluctuation amount (step S540). The rotation amount of the wheel 34 is detected by the mouse driver 18. The rotation amount of the wheel detected by the mouse driver 18 is notified with respect to the CPU 11. Accordingly, the CPU 11 acquires the rotation amount of the wheel 34 within the predetermined time as the fluctuation amount.

On acquiring the above-described fluctuation amount, the CPU 11 converts the acquired fluctuation amount into a document moving amount (step S541). The document moving amount indicates a moving document number and moving direction (rotation direction of the wheel). The moving document number indicates the number (number of documents to be moved) of documents to be switched. The moving direction corresponds to the rotation direction of the wheel, and indicates a direction in which the document is moved.

In the present embodiment, it is assumed that the moving direction is represented by a positive/negative value of the document moving amount. That is, when the wheel 34 is rotated in a positive direction, “document moving amount=+(moving document number)” is set, and the document moving amount is set to a positive value. When the document moving amount indicates the positive value in this manner, it is indicated that the documents are switched in “order”. When the wheel 34 is rotated in a reverse direction, “document moving amount=−(moving document number)” is set, and the document moving amount is set to a negative value. When the document moving amount indicates the negative value in this manner, it is indicated that the documents are switched in a reverse “order”.

For example, when the user rotates the wheel 34 in a forward direction, the document moving amount indicates a positive value, and it is indicated that the documents are switched in “order”. When the user rotates the wheel 34 in a reverse direction, the document moving amount indicates a negative value, and it is indicated that the documents are switched in the reverse “order”.

Moreover, a relation between the rotation amount of the wheel 34 of the mouse 19 and the fluctuation amount acquired by the CPU 11 is set beforehand by setting information. It is also assumed that a relation between the fluctuation amount and the document moving amount acquired by the CPU 11 is set by the setting information. The user may change the setting information to an arbitrary value.

For example, it is assumed that the fluctuation amount is “2880” with respect to one rotation of the wheel 34 of the mouse 19. In this case, when the document moving amount is set to. “1” with respect to the fluctuation amount of “1”, 2880 documents move with respect to one rotation of the wheel 34. In this setting, a moving amount is excessively large with respect to the document displayed in the image display region 41. To solve the problem, for example, when the moving document number is set to “1” with respect to a fluctuation amount of “120”, the document displayed in the image display region 41 is set in such a manner as to move by 24 documents by one rotation of the wheel 34.

Moreover, the wheel 34 of the mouse 19 is caught by a predetermined interval, that is, every constant rotation amount in some case. In the document managing apparatus 1 using the mouse 19 having this type of wheel 34, one document may be switched every catch interval accompanying the rotation of the wheel 34. This can be realized, when the moving document number is set to “1” with respect to the fluctuation amount corresponding to the rotation amount of the wheel 34 which is caught. In this case, one document may be switched every time the user operating the wheel 34 feels the catch.

When the fluctuation amount based on the rotation amount input into the wheel 34 is converted into the document moving amount (step S541), the CPU 11 sets the present document to a document which has been moved by the document moving amount (“present document=present document+document moving amount”) (step S542). In this case, the CPU 11 judges whether or not the present document set in the step S542 indicates “0” or less (step S543). When it is judged that the present document set in the step S542 indicates “0” or less (step S543, YES), the CPU 11 sets the present document to “1”, that is, the document having the latest document time (step S544).

Moreover, when it is judged that the present document set in the step S542 does not indicate “0” or less (step S543, NO), the CPU 11 further acquires the maximum order (“order” of the document having the oldest document time) from the document management table 25, and judges whether or not the present document set in the step S542 exceeds the maximum order (step S545). Here, when it is judged that the present document set in the step S542 exceeds the maximum order (step S545, YES), the CPU 11 sets the present document to the maximum order, that is, the document having the oldest document time (step S546).

When the present document is changed by the steps S540 to S546, the CPU 11 specifies the position of the present document in the document map 42 of the document searching screen 40 (step S551). On specifying the position of the present document, the CPU 11 displays the pointer 43 indicating the position of the present document in the document map 42 (step S552). That is, in the step S552, the CPU 11 changes the position of the pointer 43 in the document searching screen 40 to the position indicating the present document in the document map 42 specified in the S551.

Moreover, when the present document is changed by the steps S540 to S546, the CPU 11 judges whether or not the present document is a document produced by combining a plurality of image data files (step S553). That is, the CPU 11 judges whether or not the file which is the present document is the combined file produced by the image combining process.

When it is judged by this judgment that the present document is not produced by combining the plurality of image files (step S553, NO), the CPU 11 sets the present page to “1” which is the representative page of the document (step S554). When the present document and the present page are set by the above-described process, the CPU 11 acquires the document ID of the present document by the correspondence between “order” and “document ID” in the document management table 25. On acquiring the document ID of the present document, the CPU 11 acquires the image file of the page by the document ID of the present document and the present page (step S555). On acquiring the page image file, the CPU 11 displays the page image in the image display region 41 of the document searching screen 40 (step S556).

Moreover, when it is judged by the judgment that the present document is obtained by combining a plurality of image files (step S553, YES), the CPU 11 performs a cover image displaying process to display the cover image of the document (cover image produced in the step S116 of the above-described image combining process) (step S557). The displaying process of the cover image will be described later in detail.

It is to be noted that the process of the steps S553 to S557 may be performed in parallel with the process of the steps S551 and S552.

Moreover, the process of the steps S537 or S557 corresponds to the displaying means for displaying the cover image, and is a displaying function realized by the document management program 27.

As described above, in the document searching process shown in FIGS. 16, 17, and 18, the fluctuation amount input by the user in accordance with the rotation amount of the wheel 34 of the mouse 19 is converted into the document moving amount, the documents arranged in order of time series are switched in accordance with the document moving amount, and the image of the document switched in accordance with the document moving amount is displayed in the display. Accordingly, the wheel 34 of the mouse 19 is rotated, and the document whose image of the first page is to be displayed can be efficiently switched. As a result, the user can efficiently search the document managed by the document managing apparatus 1, and can easily find a desired document.

Next, the cover image displaying process will be described which corresponds to the step S537 or S557.

First, a first process example of the cover image displaying process will be described.

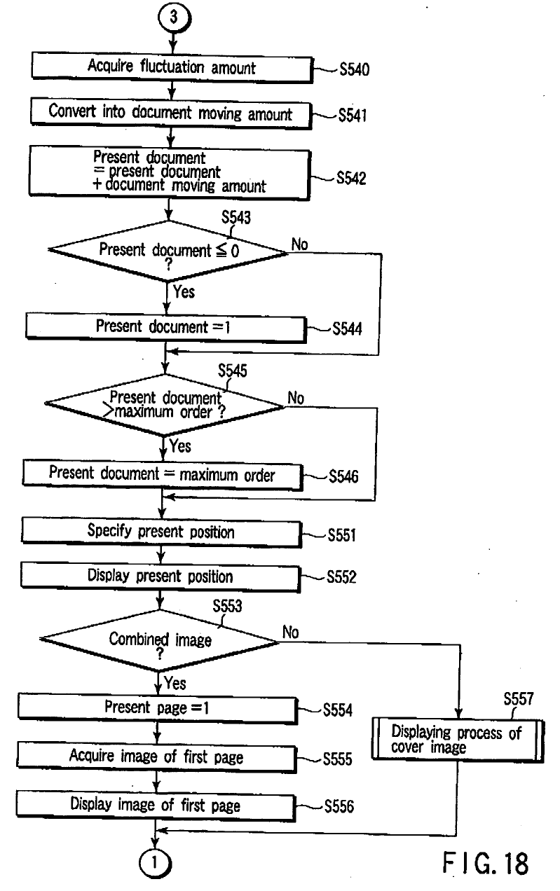

FIG. 18 is a flowchart showing a first process example of the cover image displaying process.

As described above, when it is judged in the step S533 or S553 of the document searching process that the present document is the document (document of the combined file) of a plurality of combined image files, the CPU 11 performs the displaying process of the cover image to display the cover image of the document.

In the displaying process of the cover image, the CPU 11 first sets the present page to “1” which is the page number of the document cover image (step S611) when the present page is set to the page number of the cover image, the CPU 11 acquires the cover image of the document (step S612).

In the cover image acquiring process, the CPU 11 acquires the document ID of the present document by the correspondence between the “order” and the “document ID” in the document management table 25. On acquiring the document ID of the present document, the CPU 11 acquires the image file of the cover image which is the image of the first page of the document by the document ID of the present document and the present page.

On acquiring the image file of the cover image of the document, the CPU 11 displays the cover image of the document in the image display region 41 of the document searching screen 40 by the acquired image file (step S613).

Moreover, when the cover image of the document is displayed, the timer 11a counts time elapsed from when the cover image of the document is displayed in the CPU 11. The CPU 11 judges by the timer 11a whether or not the elapsed time has reached a predetermined time from when the cover image was displayed (step S615). Accordingly, the CPU 11 displays the cover image of the document in the image display region 41 of the document searching screen 40 for the predetermined time.

While the cover image is displayed in this manner (i.e., until the predetermined time elapses from when the cover image is displayed), the CPU 11 detects whether or not there has been an input into the keyboard or mouse by the user by an input signal supplied via the keyboard interface 20 or the mouse driver 18 (step S614). In other words, when the user inputs data into the keyboard or the mouse while the display image is displayed, the CPU 11 detects occurrence of interrupt by the input signal supplied via the keyboard interface 20 or the mouse driver 18.

When the occurrence of the interrupt is detected while the cover image is displayed (step S614, YES), the CPU 11 returns to the step S502 while the display image remains to be displayed, and the CPU performs a process in accordance with the input from the user. That is, when the user inputs the data into the keyboard or the mouse while the cover image is displayed, the cover image remains to be displayed in the image display region 41 of the document searching screen 40.

Moreover, with the elapse of the predetermined time after the cover image is displayed without the above-described interrupt (step S615, YES), the CPU 11 sets the present page to “2” which is the page number of the page next to the cover image of the document (step S616). When the present page is set to the page next to the cover image, the CPU 11 acquires the image of the second page of the document (step S617). In the acquiring process of the image of the second page, the CPU 11 acquires the image file of the image of the second page in the document by the document ID of the present document and the page number (“2”) of the present page.

On acquiring the image file of the image of the second page in the document, the CPU 11 develops the acquired image file to thereby display the image of the second page of the document in the image display region 41 of the document searching screen 40 (step S618).

As described above, in the first process example of the displaying process of the cover image, first the cover image is displayed for the predetermined time in the document searching screen 40, and the image of the second page is displayed after the elapse of the predetermined time after the cover image is displayed. Accordingly, the user can first see the display image, and then see the actual image (image of the second page) constituting the document after the elapse of the predetermined time.

As a result, when the input operation is performed with respect to the keyboard or the mouse within the predetermined time after the cover image is displayed, the user can prevent the actual image (image of the second page) constituting the document from being displayed. For example, in a situation in which the user does not want others to see the actual image constituting the document (does not desire to display the image), when the user performs the operation within the predetermined time, the only display image can be remained to be displayed in the document searching screen 40.

Next, a second process example of the displaying process of the cover image will be described.

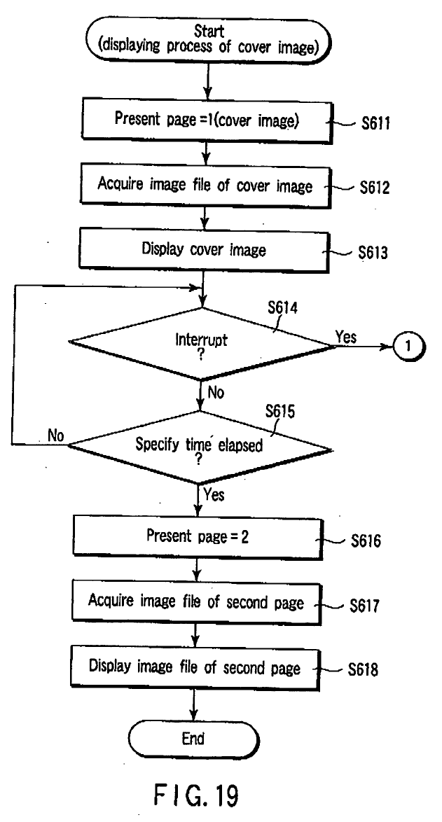

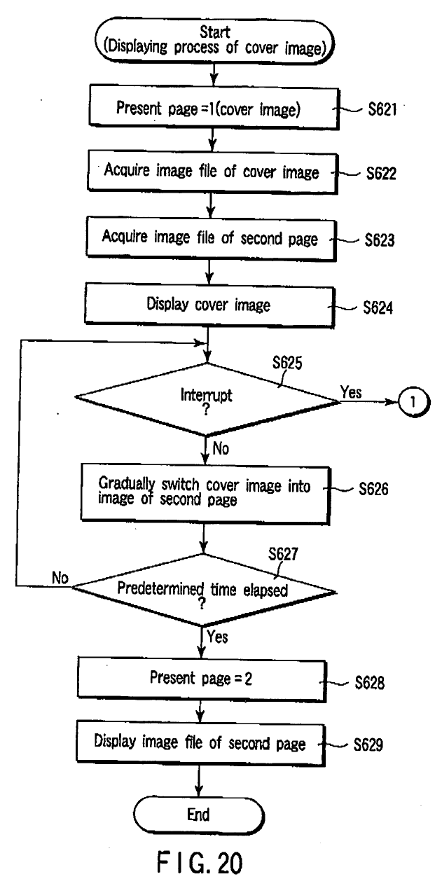

FIG. 19 is a flowchart showing a second process example of the cover image displaying process.

As described above, when it is judged in the step S533 or S553 or the document searching process that the present document is the document (document of the combined files) of a plurality of combined image files, the CPU 11 performs the displaying process of the cover image to display the cover image of the document.

The CPU 11 first sets the present page to “1” which is the page number of the document cover image (step S621). When the present page is set to the page number of the cover image, the CPU 11 acquires the cover image of the document (step S622). In the cover image acquiring process, the CPU 11 acquires the document ID of the present document by the correspondence between the “order” and the “document ID” in the document management table 25. On acquiring the document ID of the present document, the CPU 11 acquires the image file of the cover image which is the image of the first page of the document by the document ID of the present document and the present page.

On acquiring the image file of the cover image of the document, the CPU 11 acquires an image of a second page in the document as the image of the page next to the cover image (step S623). In the acquiring process of the image of the second page, the CPU 11 acquires the image file of the image of the second page in the document by the document ID of the present document and the page number (“2”) of the present page.

On acquiring the image files of the cover image and the second page of the document, the CPU 11 displays the cover image of the document in the image display region 41 of the document searching screen 40 using the image file of the display image in two acquired image files (step S624).

Moreover, when the cover image of the document is displayed, in the CPU 11, the timer 11a counts time elapsed from when the cover image of the document is displayed. The CPU 11 judges by the timer 11a whether or not the elapsed time has reached a predetermined time from when the cover image is displayed (step S627).

Moreover, the CPU 11 gradually switches to the image or the second page the cover image displayed in the image display region 41 of the document searching screen 40 from when the cover image is displayed until the predetermined time elapses (step S626). By the switching process of the image, the image of the second page in the document is gradually clearly displayed in the image display region 41 of the document searching screen 40.

Furthermore, while the cover image is gradually switched to the image of the second page (i.e., until the predetermined time elapses from when the cover image is displayed), the CPU 11 detects whether or not there has been an input into the keyboard or mouse by the user by an input signal supplied via the keyboard interface 20 or the mouse driver 18 (step S625). In other words, the user inputs data into the keyboard or the mouse from when the display image is displayed until the predetermined time elapses. Then, the CPU 11 detects occurrence of interrupt by the input signal supplied via the keyboard interface 20 or the mouse driver 18.

The occurrence of the interrupt is detected from when the cover image is displayed until the predetermined time elapses (step S625, YES). Then, the CPU 11 returns to the step S502 while the displayed state is retained in the image display region 41 of the document searching screen 40, and the CPU performs a process in accordance with the input from the user. That is, when the user inputs the data into the keyboard or the mouse while the cover image is displayed, the displayed state is retained in the image display region 41 of the document searching screen 40.

Moreover, with the elapse of the predetermined time after the cover image is displayed without the above-described interrupt (step S627, YES), the CPU 11 sets the present page to “2” which is the page number of the page next to the cover image of the document (step S628). When the present page is set to the page next to the cover image, the CPU 11 displays the image of the second page of the document in the image display region 41 of the document searching screen 40 by the image file of the image of the second page in the document acquired in the step S623 (step S629).

As described above, in the second process example of the displaying process of the cover image, first the cover image is displayed in the document searching screen 40, and the cover screen gradually switches to the image of the second page. Accordingly, the user can first see the display image, and then see the actual image (image of the second page) which gradually becomes clear. As a result, the user easily recognizes the displayed document before the cover image completely switches to the image of the second page.

Moreover, the input operation is performed with respect to the keyboard or the mouse before the Cover image completely switches to the image of the second page, and accordingly the user can prevent the actual image (images of the second and subsequent pages) from being displayed. For example, in a situation in which the user does not want others to see the actual image constituting the document (does not desire to display the image), the user performs the operation before the cover image completely switches to the image of the second page, so that the image of the second page is not completely displayed in the document searching screen 40.

As described above, in the document managing apparatus of the present embodiment, when the updated file is the file of the image data, the file is combined with the file of the image data stored in the same folder as that of the file, and a plurality of combined image data files are managed as one document.

Consequently, the plurality of image data files integrated and stored in the folder or the like can be integrated and managed as one document. When a large amount of image data are stored as the respective files in the specific folder, a large amount of image data files in the folder can be managed as different pages of one document. Even when a large amount of image data are stored as the files, a large amount of documents corresponding to the respective image data files are not the management objects, and the efficiency of the document searching can be enhanced.

Additionally, in the present embodiment, it has been described that the fluctuation amount in accordance with the rotation amount of the whole of the mouse rotating forwards/backwards is converted into the document moving amount. However, the above-described embodiment is not limited to the wheel of the mouse. That is, the wheel of the mouse in the above-described embodiment may be replaced as long as the fluctuation amount can be input in the direction corresponding to the time axis of the document map in the display screen. For example, a pointing device such as a track ball and a touch pad may be applicable instead of the wheel of the mouse in the present embodiment.

It is to be noted that in the present embodiment, it has been described that the function of carrying out the present invention is recorded beforehand in the apparatus, but the present invention is not limited to this embodiment. The similar function may be downloaded to the apparatus from the network, or the similar function stored in a recording medium may be installed in the apparatus. Any mode of the recording medium may be used such as CD-ROM as long as the program can be stored, and read by the apparatus. The function obtained beforehand by the installation or download may be realized in cooperation with an internal operating system (OS) or the like of the apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A document managing apparatus comprising:
storage means for classifying and storing files;
detecting means for detecting an updated file from the files stored in the storage means;
judging means for judging whether or not the file detected by the detecting means is a file of image data;
combining means for combining the detected file with a file of image data stored in the storage means in the same class as that of the file in a case where the judging means judges that the file detected by the detecting means is the image data; and
document managing means for managing as one document a plurality of image data files combined by the combining means.

2. The document managing apparatus according to claim 1, wherein the storage means stores the files in the folder, and
the combining means combines the file judged to be the image data by the judging means with the file of the image data stored in the same folder as that of the file.

3. The document managing apparatus according to claim 1, further comprising:
sorting means for sorting the image data file to be combined with the file judged to be the image data by the judging means from the files stored in the storage means in the same class as that of the file judged to be the image data by the judging means based on a predetermined condition,
wherein the combining means combines the file judged to be the image data by the judging means with the image data file sorted by the sorting means.

4. The document managing apparatus according to claim 1, further comprising:
time setting means for setting time information of one document constituted of a plurality of files combined by the combining means based on the time information of the respective files combined by the combining means,
wherein the document managing means manages the time information set by the time setting means as the time information of one document constituted of a plurality of files combined by the combining means.

5. The document managing apparatus according to claim 1, further comprising:
cover producing means for producing a cover image for use as a cover of one document constituted of a plurality of files combined by the combining means; and
displaying means for displaying as a document image the cover image produced by the cover producing means in a case where one document is selected which is managed by the document managing means and which is constituted of a plurality of files combined by the combining means.

6. The document managing apparatus according to claim 5, wherein the displaying means displays the cover image produced by the cover producing means for a predetermined time, and displays an image of any of the plurality of files combined by the combining means after the elapse of the predetermined time.

7. A document management program which allows a computer to realize;
a detecting function of detecting an updated file from storage means in which files are classified and stored;
a judging function of judging whether or not the file detected by the detecting function is a file of image data;
a combining function of combining the detected file with a file of image data stored in the storage means in the same class as that of the file in a case where the judging function judges that the file detected by the detecting function is the image data; and
a document managing function of managing as one document a plurality of image data files combined by the combining function.

8. The document management program according to claim 7, wherein the storage means stores the files in the folder, and
the combining function combines the file judged to be the image data by the judging function with the file of the image data stored in the same folder as that of the file.

9. The document management program according to claim 7, which further allows the computer to realize:
a sorting function of sorting the image data file to be combined with the file judged to be the image data by the judging function from the files stored in the storage means in the same class as that of the file judged to be the image data by the judging function based on a predetermined condition,
wherein the combining function combines the file judged to be the image data by the judging function with the image data file sorted by the sorting function.

10. The document management program according to claim 7, which further allows the computer to realize:
a time setting function of setting time information of one document constituted of a plurality of files combined by the combining function based on the time information of the respective files combined by the combining function,
wherein the document managing function manages the time information set by the time setting function as the time information of one document constituted of a plurality of files combined by the combining function.

11. The document management program according to claim 7, which further allows the computer to realize:
a cover producing function of producing a cover image for use as a cover of one document constituted of a plurality of files combined by the combining function; and
a displaying function of displaying in a display, as a document image, the cover image produced by the cover producing function in a case where one document is selected which is managed by the document managing function and which is constituted of a plurality of files combined by the combining function.

12. The document management program according to claim 11, wherein the displaying function displays the cover image produced by the cover producing function for a predetermined time, and displays, an image of any of the plurality of files combined by the combining function after the elapse of the predetermined time.

13. A document managing method comprising:
detecting an updated file from storage means in which files are classified and stored;
judging whether or not the detected file is a file of image data;
combining the detected file with a file of image data stored in the storage means in the same class as that of the file in a case where the judging judges that the detected file is the image data; and
managing as one document a plurality of combined image data files.

14. The document managing method according to claim 13, wherein the storage means stores the files in the folder, and
the combining comprises: combining the file judged to be the image data by the judging with the file of the image data stored in the same folder as that of the file.

15. The document managing method according to claim 13, further comprising:
sorting the image data file to be combined with the file judged to be the image data by the judging from the files stored in the storage means in the same class as that of the file judged to be the image data by the judging based on a predetermined condition,
wherein the combining comprises: combining the file judged to be the image data by the judging with the image data file sorted by the sorting.

16. The document managing method according to claim 13, further comprising:
setting time information of one document constituted of a plurality of combined files based on the time information of the respective combined files,
wherein the managing of the document comprises: managing the set time information as the time information of one document constituted of a plurality of combined files.

17. The document managing method according to claim 13, further comprising:
producing a cover image for use as a cover of one document constituted of a plurality of combined files; and
displaying the produced cover image as a document image in a case where one document is selected which is managed by the managing of the document and which is constituted of a plurality of combined files.

18. The document managing method according to claim 17, wherein the displaying comprises; displaying the produced cover image for a predetermined time, and displaying an image of any of the plurality of combined files after the elapse of the predetermined time.
